(19) United States
(12) Patent Application Publication
(10) Pub. No.: US 2014/0188792 A1
(43) Pub. Date: Jul. 3, 2014

(54) Video Replication and Placement Method

(71) Applicant: Acer Inc., New Taipei City (TW)

(72) Inventors: Chun-Kai Huang, Taipei City (TW); Chin-Chia Chang, Taipei City (TW); Wan-Jiun Liao, Taipei City (TW)

(73) Assignee: Acer Inc., New Taipei City (TW)

(21) Appl. No.: 14/091,387

(22) Filed: Nov. 27, 2013

(30) Foreign Application Priority Data
Dec. 28, 2012 (TW) 101151165

(51) Int. Cl. G06F 17/30

(52) U.S. Cl. CPC G06F 17/30575
USPC 707/610

(57) ABSTRACT

A video replication and placement method for a cloud-based center with a plurality of storage units is disclosed. The cloud-based center receives a plurality of video data according to users' demands and calculates the demand bandwidth of each video. Each video is divided into at least one standard replication conforming to a bandwidth-space ratio of the storage unit and/or a surplus replication under the ratio. The standard replications of all the videos are allocated prior to the storage units, and a remaining bandwidth-space ratio of each storage unit is calculated to allocate the surplus replications of all the videos. The amount of the used storage units can be reduced and the resource usage rate of each used storage unit can be increased.

### BACKGROUND OF THE INVENTION

1. Field of the Invention

The invention relates to a video replication and placement method, and more particularly, to a video replication and placement method used for a cloud-based center.

2. Description of the Related Art

In recent years, technologies related to cloud-based network resources have been gradually and widely utilized, such as the use of a cloud-based center formed by a plurality of entities or a virtual host structure as a resource pool for data storage or video playback processing. In the past, the cloud-based center has lacked effective and flexible resource management and has taken only the maximum demand into account. Once the cloud-based center is unable to meet the existing demand, it may choose to expand the number of entities or virtual hosts. In this method, the number of hosts to be used cannot be flexibly adjusted to meet different demands with corresponding allocations, so hosts are often idle and resources are wasted.

In addition, more popular videos or video files with larger demand bandwidths may occupy all the bandwidth of a single host, but actually the host may hold only a single file. In this case, the bandwidth supply demands are met, but other storage space of the host is wasted. As a result, not all resources of the host can be effectively used.

Accordingly, it is necessary to design each storage server such that it can be effectively and flexibly used in a cloud-based center to maximize the utilization rate and reduce the wastage of resources.

### SUMMARY OF THE INVENTION

It is a major objective of the present invention to provide a video replication and placement method used for a cloud-based center.

To achieve the above-mentioned purpose, in the video replication and placement method for a cloud-based center of the present invention, the cloud-based center includes a plurality of storage units, wherein each of the storage units has a constant total bandwidth and constant total storage space. The method includes the following steps: (a) receiving a plurality of video demands to obtain at least one video data, and calculating the corresponding demand bandwidth of each video data, wherein each of the video data has a corresponding data space (occupied data space); (b) each video data is divided into at least one standard replication and/or a surplus replication, wherein the standard segment bandwidth-occupied data space ratio corresponding to the standard replication is equal to the total bandwidth-total storage space ratio, and the surplus segment bandwidth-occupied data space ratio corresponding to the surplus replication is less than the total bandwidth-total storage space ratio; (c) allocating all standard replications of the at least one video data to at least part of the plurality of storage units; (d) determining if the storage units with the at least one standard replication allocated have sufficient surplus available resources; and (e) if the determining result in step (d) is yes, allocating all surplus replications of the at least one video data to the storage units with sufficient surplus available resources.

Through the design, in view of both the bandwidth and storage space supplied by storage units, the invention allocates all video data together to the minimum number of storage units to the greatest extent, and it effectively uses resources and flexibly manages each storage unit to make further adjustments according to different needs and changes.

### BRIEF DESCRIPTION OF THE DRAWINGS

FIG. 1 shows a cloud-based center used for the video replication and placement method of the present invention;

FIG. 2 is a flow chart showing the video replication and placement method according to a first embodiment of the invention;

FIG. 3(a) is a view showing each video data divided by the video replication and placement method of the present invention;

FIG. 3(b) is a view showing each of the divided video data allocated to the storage units;

FIG. 3(c) shows another embodiment, where each of the divided video data is allocated to the storage units;

FIG. 4(a) is a flow chart showing the video replication and placement method according to a second embodiment of the invention;

FIG. 4(b) shows the second embodiment, where the video replication and placement method of the present invention is used;

FIG. 5(a) is a flow chart showing the video replication and placement method according to a third embodiment of the invention;

FIG. 5(b) shows the third embodiment, where the video replication and placement method of the present invention is used;

FIG. 6(a) is a flow chart showing the video replication and placement method according to a fourth embodiment of the invention;

FIG. 6(b) shows the fourth embodiment, where the video replication and placement method of the present invention is used; and

FIG. 7 is a flow chart showing the video replication and placement method according to a fifth embodiment of the invention.

### DETAILED DESCRIPTION OF THE PREFERRED EMBODIMENTS

The technical content of the invention will become more apparent from the following detailed descriptions of the preferred embodiments.

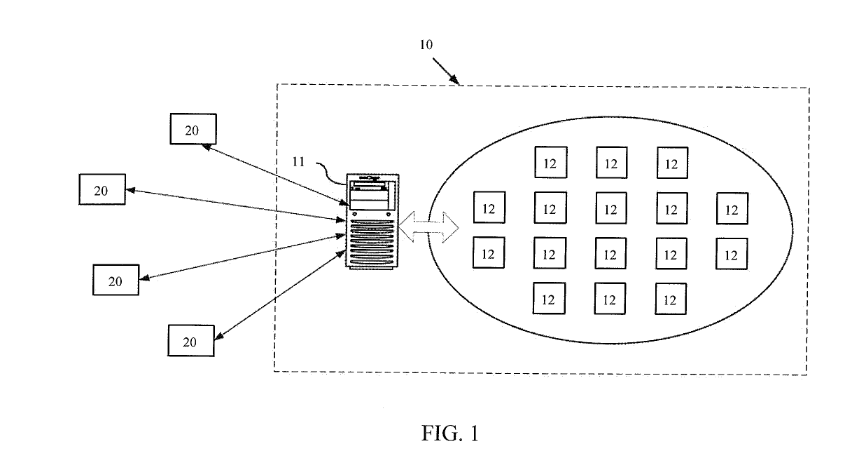

Please first refer to FIG. 1, which shows a cloud-based center 10 applicable to a video replication and placement method of the present invention. As shown in FIG. 1, the cloud-based center 10 in an embodiment of the invention includes a cloud server 11 and a plurality of storage units 12. The cloud server 11 is used for receiving video demands of the video data sent by each client side 20 and obtaining the corresponding video data, and then it calculates the corresponding demand bandwidth of each video data according to parameters of the video demand (e.g., number of requests to play the same video data and playback quality, etc.) for subsequent video processing and resource allocation.

The plurality of storage units 12 constitute a resource pool which provides bandwidth and storage space for use. Each storage unit 12 has a constant total bandwidth and constant total storage space, such that the plurality of storage units 12 are able to receive allocation commands of the cloud server 11 to save the corresponding video data and provide corresponding bandwidth for the client side 20 to connect and use or play the video data. Depending on the design requirements, each storage unit 12 may be a physical computer host or a virtual machine (VM). To achieve the purpose and implement the results of the invention, the design allows each of the storage units 12 to have equivalent total bandwidth and equivalent total storage space, such that the ratio of total bandwidth and total storage space for each storage unit 12 is equivalent.

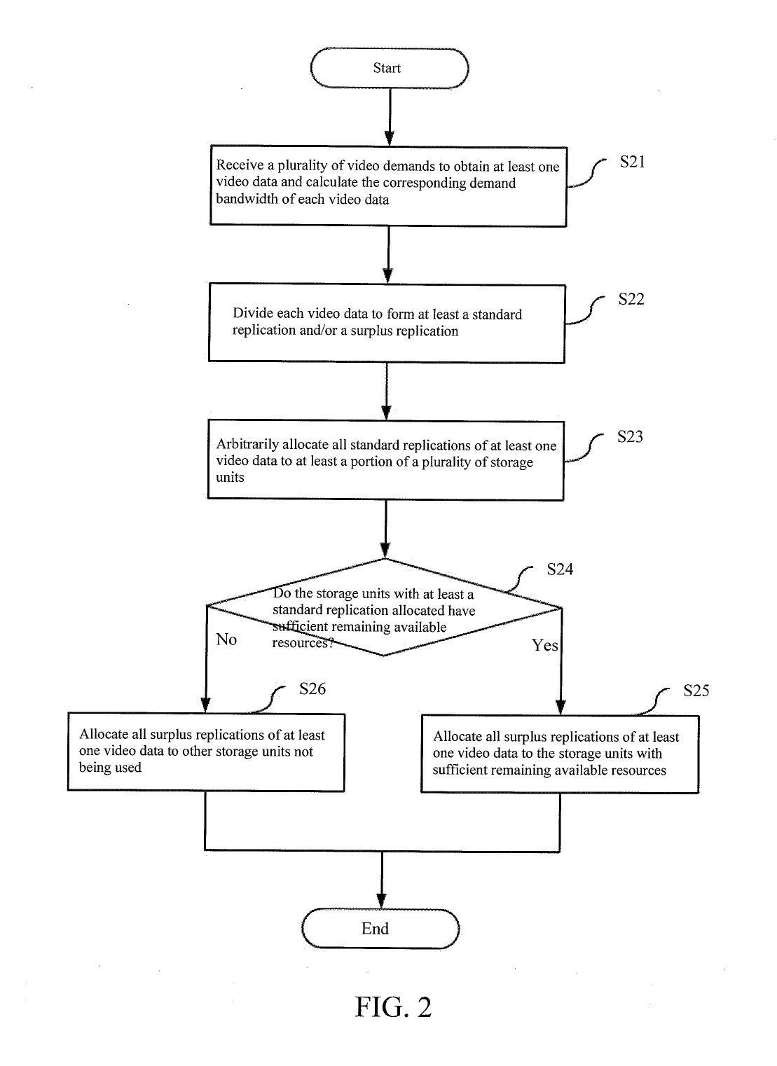

Please refer to FIG. 2, which is a flow chart showing the video replication and placement method according to a first embodiment of the invention. It should be noted that although the cloud-based center 10 as shown in FIG. 1 is used for illustrating the video replication and placement method of the invention, the present invention is not limited to this type of cloud-based center 10; any other cloud-based center with similar architecture may also be applicable to the video replication and placement method of the invention. As shown in FIG. 2, the video replication and placement method of the present invention includes Steps S21 to Step S25. Each step in the method will be described in detail hereinafter.

In Step S21, a plurality of video demands is received to obtain at least one video data and the corresponding demand bandwidth of each video data is calculated.

The client side 20 issues video demands for any of the video data. For popular videos, a plurality of client sides may simultaneously issue video demands at any point of time. Therefore, for the same video data, due to the different number of video demands or different playback quality corresponding to the video demand, it is necessary to provide different types of demand bandwidth. First, the cloud server 11 may obtain the corresponding video data when receiving a plurality of video demands. Each of the video data may be a single video data or a single video layer in the video data. Each video data has a corresponding occupied data space. Then the cloud server 11 calculates the demand bandwidth for each of the video data according to the video demands.

In Step S22, each of the video data is divided to form at least a standard replication and/or at least a surplus replication.

Under the premise that each of the storage units 12 can be effectively used, the use of the maximum transmission bandwidth and storage space of each storage unit 12 must be considered in order not to waste resources. For video data with large demand bandwidth, it is possible that a single data may occupy all the bandwidth of a storage unit 12, resulting in the waste of considerable storage space. Accordingly, the method of the invention uses the total bandwidth-total storage space ratio (i.e., bandwidth-space ratio) of the storage units 12 as a reference to divide each of the video data and form at least one standard replication and/or a surplus replication corresponding to each of the video data, where the standard replication corresponds to one standard segment bandwidth, and the standard segment bandwidth-occupied data space ratio is equal to the total bandwidth-total storage space ratio of the storage units 12; the surplus replication corresponds to one surplus segment bandwidth; the surplus segment bandwidth-occupied data space ratio is less than the total bandwidth-total storage space ratio of the storage units 12. The standard replication and surplus replication of the same video data described above have the same amount of occupied space as the original video data, and the difference between the two is that the respective corresponding bandwidth value is not equivalent.

In Step S23, all standard replications of the at least one video data are randomly allocated to part of the plurality of storage units.

After each video data has been divided in the proceeding Step S22, all the standard replications and surplus replications being formed will be allocated to at least a portion of the plurality of storage units. First, all standard replications of all video data are allocated to the storage units. Since each standard replication has the equivalent bandwidth-space ratio compared with a storage module, the allocation of each standard replication must be considered first, such that the bandwidth and storage space in the storage units 12 can be fully utilized. In an embodiment of the invention, the cloud server 11 arbitrarily allocates all standard replications of all video data to one or more storage units 12 depending on the number of standard replications and amount of space occupied.

Basically, to determine whether a standard replication can be allocated to any of the storage units, whether the remaining available resources (i.e., remaining bandwidth and remaining storage space) in the storage units are sufficient must be confirmed. Since the bandwidth-space ratio of each standard replication and the bandwidth-space ratio of the storage units coincide with each other, the basis of determination described above can be confirmed by comparing the diagonal length corresponding to the remaining block of the rectangle (which represents the storage unit) with the diagonal length of the rectangular block formed by each of the standard replications. Accordingly, the present invention can use the length of a simple one-dimensional line to determine whether the storage unit is large enough to accommodate a standard replication. The aforementioned remaining available resources can be given by the following formula:

√((remaining bandwidth of the storage unit)²+(remaining storage space of the storage unit)²) (1)

The required resource for each of the standard replications can be given by the following formula:

√((standard segment bandwidth of standard replication)²+(occupied data space of standard replication)²) (2)

In the case that a storage unit is not used, since its remaining bandwidth is equal to its total bandwidth, and the remaining storage space is equal to the total storage space, the standard replications can be arbitrarily allocated to the storage unit. With one-by-one allocation of the standard replications, a portion of the bandwidth and storage space of the storage unit is occupied, and thus the remaining available resources of the storage unit are calculated by the aforementioned formula (1) for being compared with the standard replications to be allocated in formula (2) in order to determine whether the standard replications can be successfully allocated to the corresponding storage unit. If the result value of formula (1) is greater than that of formula (2), it indicates that the standard replication can be successfully allocated to the corresponding storage unit; otherwise, it cannot.

In Step S24, it is determined whether the storage units 12 with at least one standard replication allocated have sufficient remaining available resources.

In the preceding Step S23, after all standard replications of all video data are arbitrarily allocated to one or more storage units 12, the cloud server 11 will confirm the remaining available resources of each storage unit 12 with at least one standard replication allocated for subsequent allocation of the surplus replications. Since the bandwidth-space ratio of the surplus replications and the bandwidth-space ratio of the storage units 12 do not coincide with each other, the surplus available resources of the storage unit 12 can no longer be calculated by the aforementioned formula. Accordingly, it is necessary to further confirm the remaining storage space and remaining bandwidth of the storage units 12, which are used for comparison with the surplus segment bandwidth and occupied data space of each surplus replication formed in the aforementioned video data to determine whether the remaining available resources of the used storage unit 12 are sufficient to be used as the basis for subsequent step implementation.

In this case, the inner product of two two-dimensional vectors can be used to calculate the remaining available resources of the storage unit 12.

At this time, the remaining available resources of the storage unit 12 can be given by the following formula:

(Total bandwidth and total storage space of the storage unit)·(Remaining bandwidth and remaining storage space of the storage unit) (3)

Similarly, the required occupied resources of each of the surplus replications can also be calculated by using the inner product of two two-dimensional vectors according to the following formula:

(Surplus segment bandwidth and occupied data space of the surplus replication)·(Remaining bandwidth and remaining storage space of the storage unit) (4)

The remaining available resources of the storage units are calculated by the aforementioned formula (3) to check the resources required for the surplus replication to be allocated by formula (4) and determine whether the surplus replication can be successfully allocated to the corresponding storage unit. If the resulting value of formula (3) is greater than that of formula (4), it indicates that the surplus replication can be successfully allocated to the corresponding storage unit; otherwise, it cannot.

In Step S25, if yes, all surplus replications of at least one video data are allocated to the storage units with enough remaining space and remaining bandwidth. If no, all surplus replications of at least one video data are allocated to the storage units that are not being used.

If at least one standard replication with sufficient remaining space and remaining bandwidth has been allocated to the storage units 12, it means that the storage units can accommodate the surplus replications formed by the video data described above. Therefore, the cloud server 11 can allocate each of the surplus replications to the corresponding storage unit with sufficient remaining space and remaining bandwidth to fully utilize the bandwidth and storage space of each of the used storage unit. However, if the storage units 12 with at least one standard replication allocated do not have sufficient remaining space or remaining bandwidth, it means that the currently used storage units 12 cannot accommodate other surplus replications. As such, the cloud server 11, in the case of no choice, will provide one or more of the unused storage units to allocate the surplus replications.

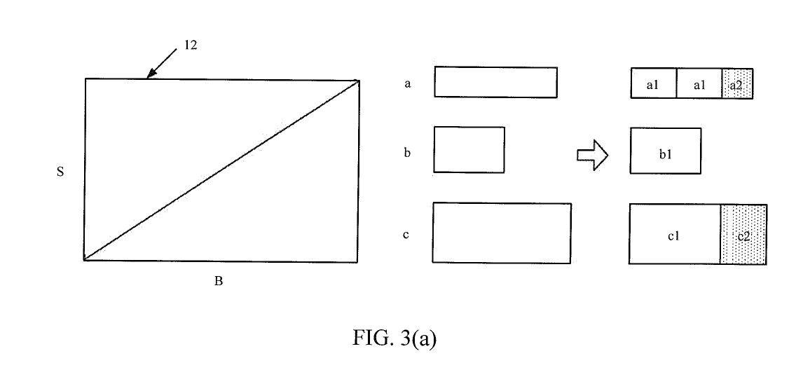

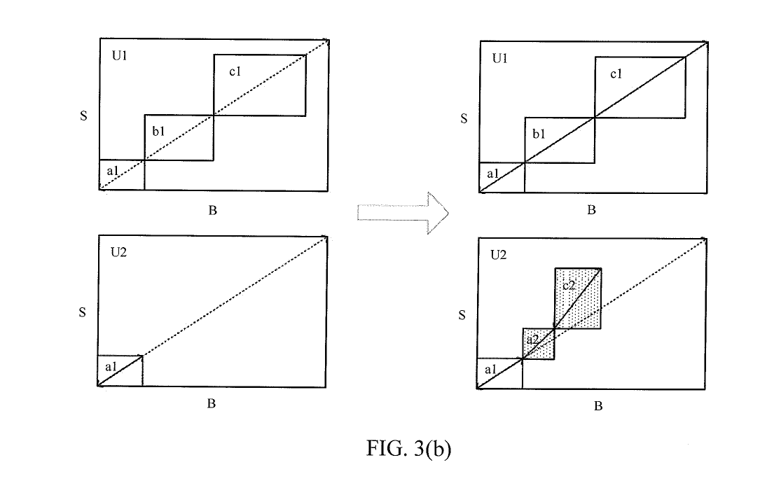

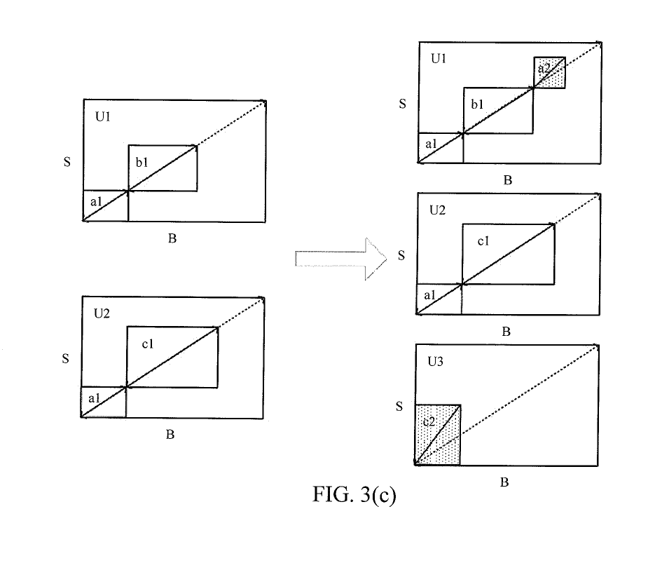

Please refer to all of FIGS. 3(a) to 3(c) hereinafter, where FIG. 3(a) is a view showing each video data being divided by the video replication and placement method in the present invention; FIG. 3(b) is a view showing each of the divided video data allocated to the storage units; and FIG. 3(c) shows another embodiment, where each of the divided video data is allocated to the storage units.

In FIG. 3(a), assume that a rectangle on the left of FIG. 3(a) represents one of the storage units in a cloud-based center, where the length is the total bandwidth B, and the width is the total storage space S. There are different rectangles corresponding to video data a, b, c on the right of the figure, where each of the video data corresponds to different occupied data space (length) and demand bandwidth (width) that have changed in response to demands.

The method of the present invention uses the ratio of the total bandwidth B and the total storage space S of the storage unit described above (i.e., assuming the ratio of the length and width of the rectangle is 3:2) as a reference to divide each of the video data a, b, and c and form one or more rectangular blocks, where each block can be regarded as a backup of the corresponding video data. These blocks can be divided into the standard replications and/or surplus replications as described above. The video data a can be divided into two standard replications al and one surplus replication a2, the video data b is overall exactly a standard replication b1, and the video data c can be divided into one standard replication c1 and one surplus replication c2. The standard segment bandwidth-occupied data space ratio in each of the standard replications a1, b1 , or c1 is 3:2. The block of each surplus replication a2, c2 is respectively smaller than the block of each standard replication a1, c1 (i.e., the surplus segment bandwidth corresponding to each surplus replication a2, c2 is respectively less than the standard segment bandwidth of each standard replication a1, c1).

As shown in FIG. 3(b), at first, each of the standard replications formed by dividing all video data is allocated to the storage units.

As shown on the left in FIG. 3(b), in this embodiment, which is calculated according to the aforementioned allocation, the storage unit U1 is available for allocating the standard replications a1, b1, c1 of the video data a, b, c; the storage unit U2 is available for allocating the standard replication al of the video data a. The system will allocate each of the standard replications a1, b1, c1 formed by dividing all video data according to the aforementioned calculation to the storage units U1 and U2.

Then each of the surplus replications a2, c2 formed by dividing all video data is allocated. After determining that the storage unit U1 has no sufficient remaining storage space or remaining bandwidth to accommodate the surplus replications a2, c2, and that the storage unit U2 has sufficient remaining storage space and remaining bandwidth, the surplus replications a2, c2 can be respectively allocated to the storage unit U2, as shown on the right in FIG. 3(b). At this time, only two sets of storage units U1, U2 are used, which achieves the effective use of resources.

As shown on the left in FIG. 3(c), in another embodiment, assuming the available resources of the storage units U1, U2 are relatively less, the storage unit U1 is available for allocating the standard replications a1, b1 of the video data a, b, and the storage unit U2 is available for allocating the standard replications a1, c1 of the video data a, c. When the surplus replications a2, c2 are allocated, the storage unit U1 still has remaining storage space and remaining bandwidth for allocating the surplus replication a2, while the storage unit U2 no longer has sufficient remaining storage space or remaining bandwidth for accommodating the surplus replication c2. As such, the system needs to additionally open and use the storage unit U3 for allocating the surplus replication c2, as shown on the right in FIG. 3(c). At this time, three sets of storage units U1, U2, U3 need to be used, such that the present invention can flexibly utilize resources in response to different circumstances.

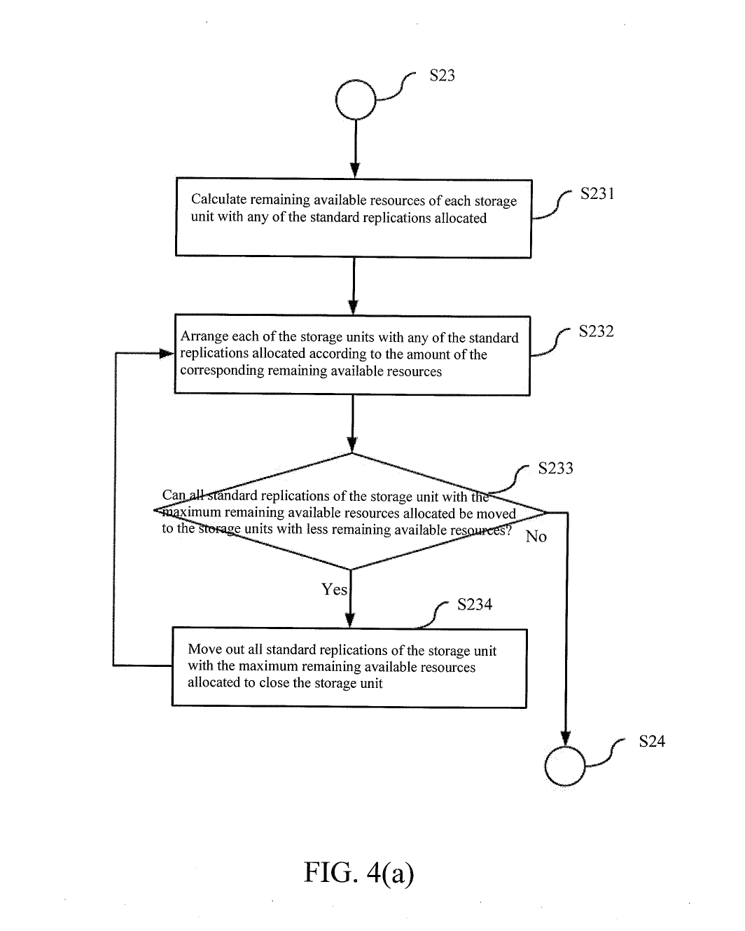

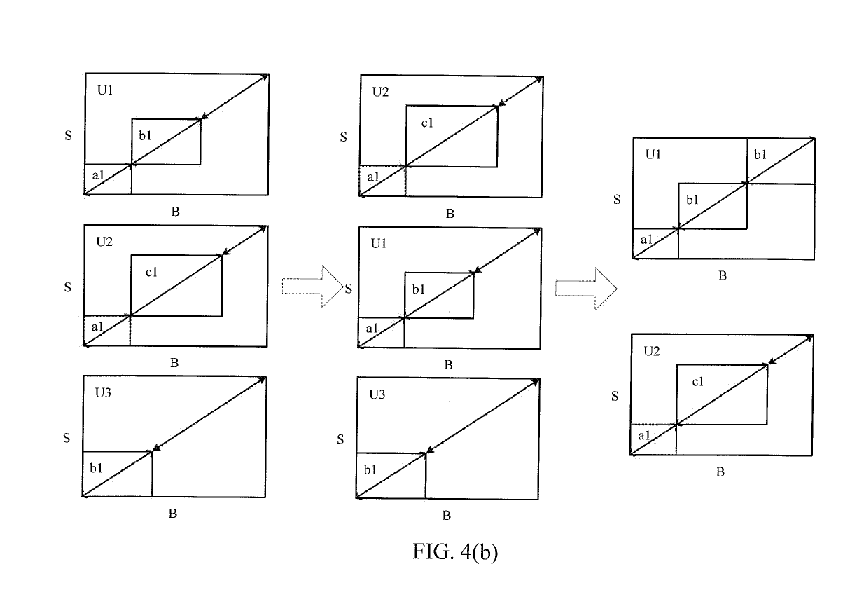

Please refer to FIG. 4(a), which is a flow chart showing the video replication and placement method according to the second embodiment of the invention. As shown in FIG. 4(a), the second embodiment is a variation of the aforementioned first embodiment. In this embodiment, Step S23 further includes Steps S231 to S234. Each of the newly added steps in the method will be described in detail hereinafter.

In Step S231, the remaining available resources of each storage unit with any of the standard replications allocated are calculated.

After each standard replication of all video data is allocated to one or more storage units, the system can calculate the remaining available resources with respect to each storage unit with a standard replication allocated (i.e., each of the used storage units). Since all of the formed standard replications are arbitrarily allocated using random numbers to each of the storage units in the invention, the resource usage states of the storage units are not the same. Accordingly, it is necessary to calculate the remaining available resources of each storage unit separately. The remaining available resources of each storage unit are calculated with formula (1) above.

In Step S232, each storage unit with any of the standard replications allocated is arranged according to the amount of the corresponding remaining available resources.

After the respective remaining available resources of each used storage unit are calculated in the preceding Step S231, the storage units can be arranged according to the amounts of their remaining available resources to confirm which storage units have more remaining available resources and which storage units have insufficient remaining available resources.

In Step S233, it is determined whether all standard replications allocated to the storage unit with the maximum remaining available resources can be moved to the storage units with less remaining available resources.

To flexibly allocate resources and avoid waste of resources, after the remaining available resources of each storage unit are arranged by amount in the preceding Step S232, the system will further determine whether all standard replications allocated in the storage unit with the maximum remaining available resources can be moved to other storage units with less remaining available resources. If the result is yes, proceed to Step S234; if the result is no, proceed to Step S24.

In Step S234, all the standard replications allocated to the storage unit with the maximum surplus available resources are moved out and the storage unit is closed, and then Step 5232 is repeated.

If it is determined that other storage units have less remaining available resources, the remaining available resources can accommodate all of the standard replications allocated to the storage unit with the maximum remaining available resources. The system will move all standard replications allocated to the storage unit with the maximum remaining available resources to one or more storage units with less remaining available resources for effective use of the remaining available resources of the storage units. After all of the standard replications have been moved out of the storage unit, the system can close the empty storage unit. With this operation, at least a portion of the remaining available resources of the storage unit has been changed, and thus the system will repeat Step S232 to determine whether the next storage unit with the maximum remaining available resources can continue to be emptied, and so on, until the system determines that no storage units can be emptied, and then the system will perform the subsequent Step S24.

Please refer to FIG. 4(b), which shows the second embodiment, where the video replication and placement method of the invention is used. As shown on the left in FIG. 4(b), assuming that after all standard replications are randomly allocated, a total of three storage units U1, U2, U3 are used. The system first calculates the remaining available resources (as shown in bold bidirectional arrows) of each storage unit U1, U2, U3. At this time, it can be found that the storage unit U3 has the most remaining available resources and the storage unit U2 has the least remaining available resources. Accordingly, the storage units are arranged in order according to the amount of the remaining available resources, as shown in the center part of FIG. 4(b). When determining that the storage is unit U1 has sufficient remaining available resources to accommodate the standard replication b1 currently allocated in the storage unit U3, the system will move the standard replication b1 from the storage unit U3 to the storage unit U1. Since the inside of the storage unit U3 has been emptied—i.e., there is no need to use it—the system will close the storage unit U3, as shown on the far right in FIG. 4(b). After it is determined that the storage units U1, U2 can no longer be changed, subsequent allocation of each surplus replication will be started.

As a result, when all standard replications are randomly allocated to the storage units, it is possible to avoid the situation that some of the storage units may be allocated only a single or part of a standard replication, which results in wastage of the resources of the storage units, and the number of storage units used can simultaneously be minimized.

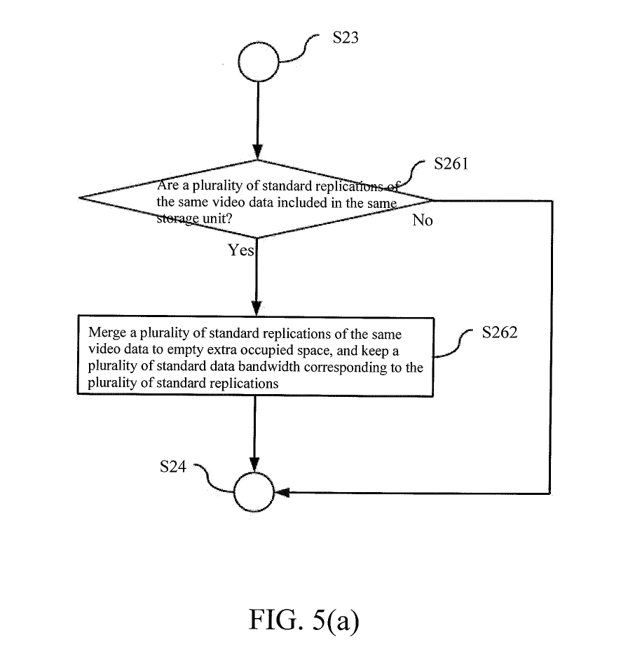

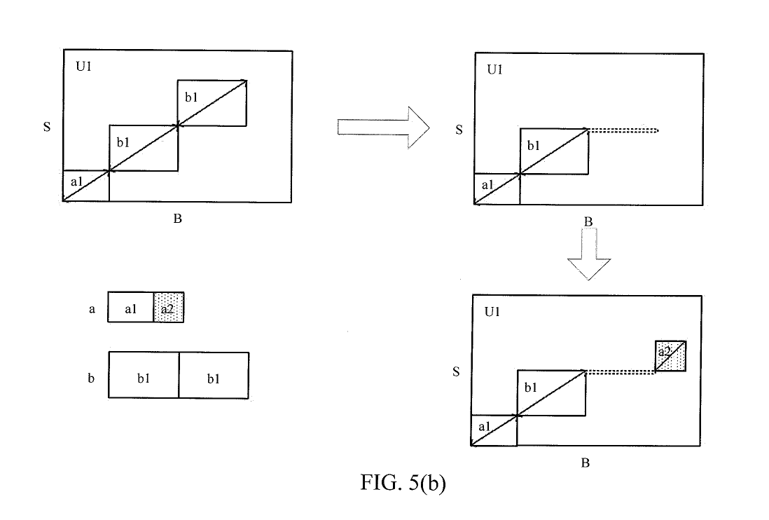

Please refer to FIG. 5(a), which is a flow chart showing the video replication and placement method according to the third embodiment of the invention. As shown in FIG. 5(a), the embodiment is a variation of the aforementioned first embodiment. In this embodiment, Steps 5261 to S262 are included between Step S23 and S24. It should be noted that the process of the embodiment can be performed separately or integrated with aforementioned second embodiment. Each of the newly added steps in the method will be described in detail hereinafter.

In Step S261, it is determined whether a plurality of standard replications of the same video data is included in the same storage unit.

As described above, since the demand bandwidth for the same video data is too large to divide into more than one of the same standard replications, when each of the standard replications is arbitrarily allocated to one or more storage units, it is possible that two or more standard replications of the same video data are included in the same storage unit. Consequently, multiple copies of the same standard replication may exist in a single storage unit, thus repeatedly occupying storage space in the storage unit. The system determines whether a plurality of standard replications of the same video data is included in each storage unit.

In Step S262, if the determining result yes, a plurality of standard replications of the same video data are merged to delete superfluous occupied data space, and a plurality of standard data bandwidth is reserved corresponding to the plurality of standard replications.

Since a single storage unit needs only one copy of the standard replication of the same video data, if the system determines that a plurality of standard replications of the same video data exist in the same storage unit, the system will merge the standard replications. That is, only one standard replication will be kept, and other superfluous data will be deleted, and the existing plurality of standard data bandwidth corresponding to a plurality of standard replications will be merged as its actual standard data bandwidth. In this way, the remaining storage space in the storage unit will be emptied for allocation of other information.

Please refer to FIG. 5(b), which shows a third embodiment using the video replication and placement method of the present invention. As shown on the lower left in FIG. 5(b), assume a total of two video data a and b, wherein the video data a is divided into one standard replication al and one surplus replication a2, and the video data b is divided into two standard replications b1. As shown on the upper left in FIG. 5(b), after initial allocation of all standard replications a1, b1 of the video data a, b, since the two standard replications b1 repeatedly occupy storage space of the storage unit U1, in actual practice, the present method merges the two standard replications b1 by deleting one standard replication b1 from the occupied storage space and keeping only one standard segment bandwidth; i.e., the method increases the occupied bandwidth of the original single standard replication b1, as shown on the upper right in FIG. 5(b). After the method is implemented, the bandwidth-space ratio of the remaining available space in the storage unit U1 is different from the total bandwidth-space ratio in the storage unit U1. Accordingly, the remaining resources are more suitable for the allocation of other surplus replications; e.g., the surplus replication a2 allocated on the lower-right side of FIG. 5(b).

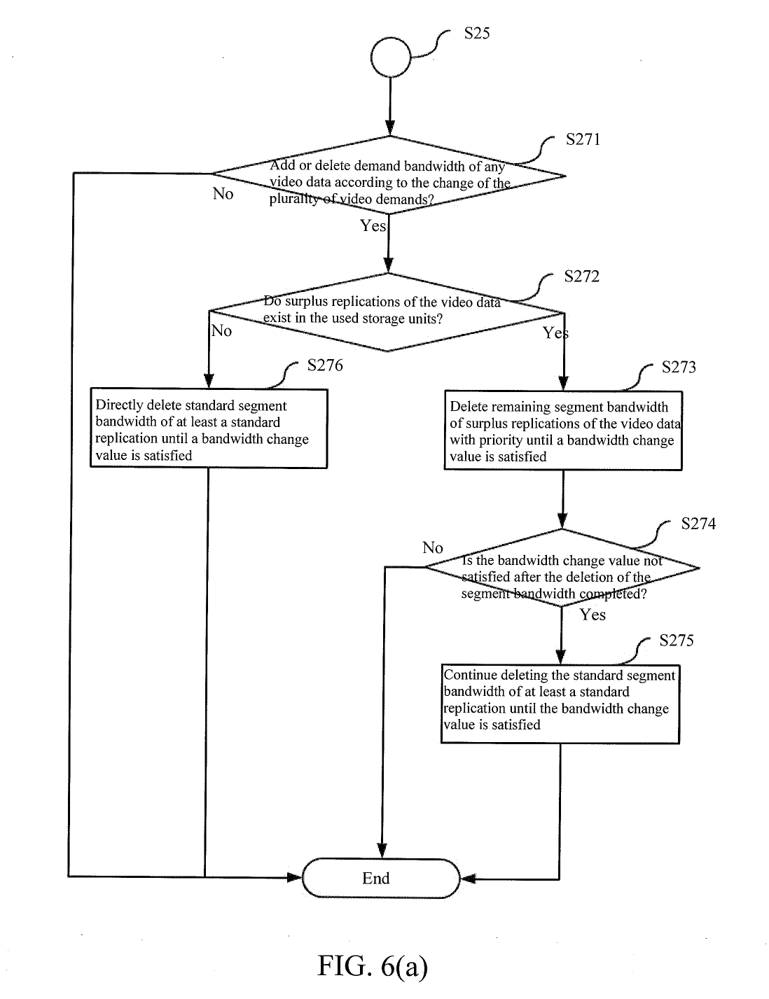

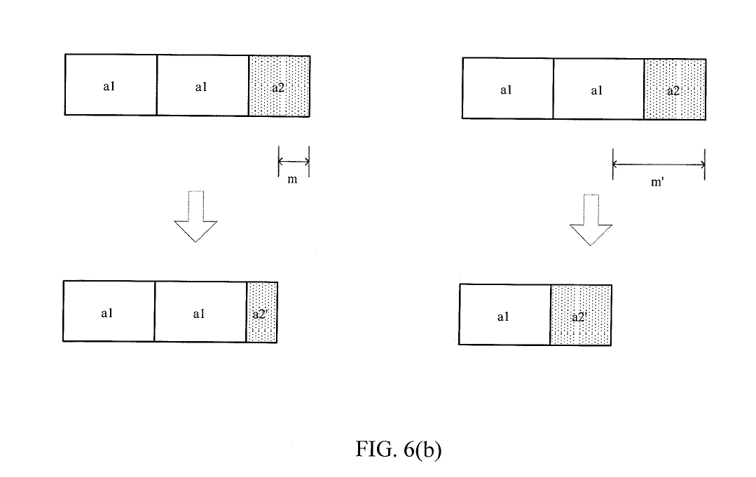

Please refer to FIG. 6(a), which is a flow chart showing the video replication and placement method according to the fourth embodiment of the invention. As shown in FIG. 6(a), the embodiment is a variation of the aforementioned first embodiment. In this embodiment, Steps S271 to S276 are included after Step S25. Each of the newly added steps in the method will be described in detail hereinafter.

In Step S271, it is determined whether the demand bandwidth of any video data is deleted according to the change in a plurality of video demands.

The video replication and placement method of the present invention determines the allocation of each data according to the received plurality of video demands in the aforementioned Step S21. Since each video demand is issued, changes, or stops changing with the demand of the client side, the data provided by the cloud-based center must be added or deleted according to the demand bandwidth of any of the video data. Accordingly, the method of the invention needs to be implemented and operated at any time in accordance with changes in the plurality of video demands. When receiving changes in a plurality of video demands, the system will determine whether the changes require deleting demand bandwidth of any video data. If yes, proceed to Step S272.

In Step S272, if the change described above requires deleting demand bandwidth of any the video data, it is determined whether surplus replications of the video data are included in the used storage units.

When determining that the change requires deleting demand bandwidth of the video data, first, the system needs to know which part of the video data to start deleting. Basically, for the same video data, surplus replications will be more resource intensive than standard replications. Therefore, the system will further determine whether the surplus replications of the video data requiring deletion as described above exist in the used storage units. If the determining result is yes, proceed to Step S273; if the determining result is no, proceed to Step S276.

In Step S273, the remaining segment bandwidth of surplus replications of the video data is preferably deleted until a bandwidth change value is satisfied.

When it is necessary to delete the demand bandwidth of certain video data and surplus replications of the video data are included in the currently used storage units, it is preferred to delete the remaining segment bandwidth corresponding to the surplus replications of the video data until the deleted amount of bandwidth meets a bandwidth change value.

In Step S274, it is determined whether the bandwidth change value still cannot be satisfied after the remaining segment bandwidth is deleted.

If the bandwidth change value described above is less than the remaining segment bandwidth of the surplus replication in the video data, the bandwidth change value can be satisfied by performing Step S273. However, if the bandwidth change value described above is greater than the remaining segment bandwidth of the surplus replication in the video data, the required bandwidth change value still cannot be achieved after the remaining segment bandwidth is deleted. If so, proceed to Step S275.

In Step S275, the standard segment bandwidth of at least one standard replication is deleted continuously until the bandwidth change value is satisfied.

If the bandwidth change value still cannot be satisfied after the deletion of remaining segment bandwidth has been completed, the deletion of the standard segment bandwidth corresponding to at least one standard replication of the video data will be continued until the deleted is bandwidth value meets the change value. If the required bandwidth change value is not reached after the standard segment bandwidth of at least one standard replication of the video data has been deleted, the deletion of the standard segment bandwidth of another standard replication will be continued until the bandwidth change value is satisfied.

In Step S276, the standard segment bandwidth of at least one standard replication is directly deleted until the bandwidth change value is satisfied.

When it is necessary to delete demand bandwidth of certain video data and only standard replications of the video data are included in the currently used storage units, the standard segment bandwidth corresponding to at least one standard replication of the video data are directly deleted until the deleted bandwidth value meets the change value. If the required bandwidth change value is not reached after the standard segment bandwidth of at least one standard replication in the video data has been deleted, the standard segment bandwidth of another standard replication will be deleted continuously until the bandwidth change value is satisfied.

After the bandwidth change value described above is satisfied, the data distribution of the preceding Steps S23 to S25 is performed with respect to the changed video data, depending on the circumstances, to optimize overall resource utilization.

Please refer to FIG. 6(b), which shows a fourth embodiment using the video replication and placement method of the present invention. As shown on the left in FIG. 6(b), assume the original video data a is divided into two standard replications al and one surplus replication a2. When the video demand is changed and the demand bandwidth of the video data a needs to be deleted, the surplus segment bandwidth of the surplus replication a2 is preferably deleted according to the bandwidth change value m. In the case that the remaining segment bandwidth of the existing surplus replication a2 can meet the bandwidth change value m, the surplus replication a2 will change to the new surplus replication a2′. As shown on the right in FIG. 6(b), if the remaining segment bandwidth of the surplus replication a2 cannot meet the bandwidth change value m′, that is, in the case that all of the remaining segment bandwidth has not yet reached the bandwidth change value m′ after the surplus replication a2 has been deleted, the standard segment bandwidth of the existing standard replication al will further be deleted until the deleted amount of bandwidth meets the bandwidth change value m′. It is preferred to delete the remaining segment bandwidth of the surplus replication a2. Since the standard replication al, whose bandwidth is deleted, does not contain the characteristic of a standard replication, it is changed to a new surplus replication a2′. Then the aforementioned data distribution from Steps S23 to S25 is performed again in accordance with the changed video data a to optimize overall resource utilization.

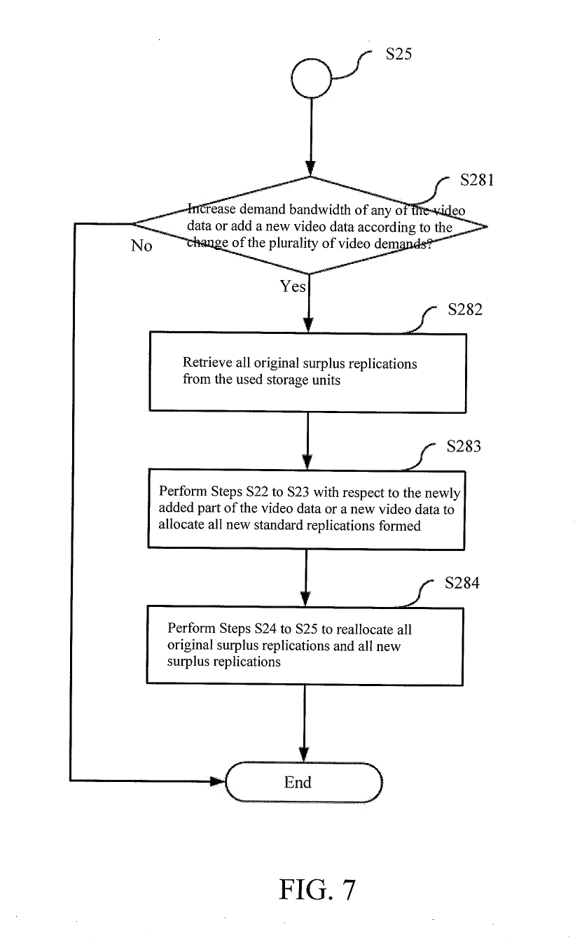

Please refer to FIG. 7, which is a flow chart showing the video replication and placement method according to the fifth embodiment of the invention. As shown in FIG. 7, the embodiment is a variation of the aforementioned first embodiment. In this embodiment, Steps S281 to S284 are included after Step S25. It should be noted that the process of the embodiment can be performed separately or integrated with the aforementioned fourth embodiment. Each of the newly added steps in the method will be described in detail hereinafter.

In Step S281, whether to increase the demand bandwidth of any video data or a new video data is determined based on the change in the plurality of video demands.

When receiving the change in the plurality of video demands, the system will determine whether to request an increase in the demand bandwidth of any video data or to add a new video data. If yes, proceed to Step S282.

In Step S282, if the demand bandwidth of any video data or a new video data is added according to the change, all the original surplus replications are moved out of the used storage units.

In the case of determining that the demand bandwidth of any video data or a new video data is to be added, then in order to effectively reallocate bandwidth and storage space in the storage units, all of the more resource-intensive original surplus replications need to be moved out of the used storage units first in order to make room for the allocation of other standard replications that can effectively use resources.

In Step S283, Steps S22 to S23 are performed with respect to the newly added part of the video data or the new video data to allocate all new standard replications.

The system will perform the aforementioned Steps S22 to S23 with respect to the newly added part of the existing video data or the new video data such that each of the newly added parts of the existing video data or the new video data is divided into at least a new standard replication and/or a new surplus replication, and then all the new standard replications are allocated to the storage units.

In Step S284, Steps S24 to S25 are performed to reallocate all original surplus replications and all new surplus replications.

After Step S24 is performed to determine which storage units among the used storage units have sufficient remaining storage space and remaining bandwidth, all original surplus replications and all new surplus replications moved out in the aforementioned Step S282 are reallocated to the suitable storage units to achieve the data reallocation effect with the changes in demand.

Through the design of the invention, the cloud-based center can take advantage of the aforementioned method to dynamically adjust its allocation of resources to the minimum number of storage units to make the most effective use of resources and reduce waste of resources based on different needs and changes over time.

As described above, the objectives, means, and effectiveness in the present invention are different from the characteristics in the prior art. It should be noted that the embodiments described above are for illustrating the principles and effects of the present invention and are not for limiting the scope of the present invention. Any person skilled in the art shall be able to make modifications and changes to the embodiments without departing from the technical principle and sprit of the present invention. The claims of the present invention within the scope of protection are described below.

What is claimed is:

1. A video replication and placement method applicable to a cloud-based center, the cloud-based center comprising a plurality of storage units, each of the storage units having a constant total bandwidth and total storage space, the method comprising the following steps:
(a) receiving a plurality of video demands to obtain at least one video data and calculating a corresponding demand bandwidth of each video data, wherein each of the video data has one corresponding occupied data space;
(b) dividing each of the video data to form at least a standard replication and/or a surplus replication, a standard segment bandwidth-occupied data space ratio corresponding to the standard replication being equal to the total bandwidth-total storage space ratio, and a surplus segment bandwidth-occupied data space ratio corresponding to the surplus replication being less than the total bandwidth-total storage space ratio;
(c) allocating all standard replications of at least one video data to at least a portion of the plurality of storage units;
(d) determining if the storage units with at least a standard replication allocated have a sufficient remaining available resources; and
(e) if the determining result in Step (d) is yes, allocating all surplus replications of at least one video data to the storage units with the sufficient surplus available resources.

2. The method as claimed in claim 1, wherein the Step (c) further comprises the following steps:
(c1) calculating the remaining available resources of each of the storage unit with any of the standard replications allocated;
(c2) arranging each of the storage units with any of the standard replications allocated according to the amount of the corresponding surplus available resources;
(c3) determining whether all the allocated standard replications in the storage unit with the greatest amount of remaining available resources can be moved to the storage units with less remaining available resources; and
(c4) if the determining result in Step (c3) is yes, moving all the allocated standard replications from the storage unit with the greatest amount of remaining available resources to close the storage unit, and then repeating Step (c2); if the determining result in Step (c3) is no, proceed to Step (d).

3. The method as claimed in claim 2, wherein the remaining available resources of each of the storage unit in the Step (c1) are given by the following formula:
((surplus bandwidth of the storage unit)²+(surplus storage space of the storage unit)²).

4. The method as claimed in claim 1, wherein the remaining available resources of each of the storage unit in Step (d) is given by the inner product of the following formula:
(the total bandwidth and total storage space of the storage unit)□□ the remaining bandwidth and remaining storage space of the storage unit).

5. The method as claimed in claim 1, further comprising the following steps before Step (d):
(g1) determining if a plurality of standard replications of the same video data are included in the same storage unit; and
(g2) if the determining result in Step (g1) is yes, merging the plurality of standard replications of the same video data to delete data from the unnecessarily occupied data space, and reserving a plurality of standard data bandwidth corresponding to the plurality of standard replications.

6. The method as claimed in claim 2, further comprising the following steps before Step (d):
(g1) determining if a plurality of standard replications of the same video data are included in the same storage unit; and
(g2) if the determining result in Step (g1) is yes, merging the plurality of standard replications of the same video data to delete data from the unnecessarily occupied data space, and reserving a plurality of standard data bandwidth corresponding to the plurality of standard replications.

7. The method as claimed in claim 1, further comprising the following steps after the Step (e):
(h1) determining whether to delete the demand bandwidth from any of the video data according to a change in the plurality of video demands;
(h2) if any demand bandwidth is deleted from any of the video data according to the change, determining whether a surplus replication of the video data exists in the storage unit; and
(h3) if the determining result in Step (h2) is yes, it is preferred to delete the remaining segment bandwidth of the surplus replications of the video data until a bandwidth change value is satisfied; if the bandwidth change value is still not satisfied after the surplus segment bandwidth has been deleted, the standard segment bandwidth of the at least one standard replication of the video data is deleted continuously until the bandwidth change value is satisfied; if the determining result in Step (h2) is no, the standard segment bandwidth of at least one standard replication in the video data is deleted directly until the bandwidth change value is satisfied.

8. The method as claimed in claim 1, further comprising the following steps after Step (e):
(i1) determining whether to increase the demand bandwidth of the video data or a new video data according to the change in the plurality of video demands;
(i2) moving all the original surplus replications out of the used storage units if the demand bandwidth of the video data or any new video data is added according to the change; and
(i3) performing Steps (b) to (c) with respect to the newly added part of the video data or the new video data to allocate all new standard replications, and performing Steps (d) to (e) to reallocate all original surplus replications and all new surplus replications.

9. The method as claimed in claim 7, further comprising the following steps after Step (e):
(i1) determining whether to increase the demand bandwidth of the video data or a new video data according to the change in the plurality of video demands;
(i2) moving all the original surplus replications out of the used storage units if the demand bandwidth of the video data or any new video data is added according to the change; and
(i3) performing Steps (b) to (c) with respect to the newly added part of the video data or the new video data to allocate all new standard replications, and performing Steps (d) to (e) to reallocate all original surplus replications and all new surplus replications.

10. The method as claimed in claim 7, wherein when either the standard replication or surplus replication of the video data is deleted to as 0 bandwidth, the standard replication or surplus replication will be moved out of the storage units.

11. The method as claimed in claim 1, wherein all standard replications of the at least one video data are arbitrarily allocated with random numbers to at least part of the plurality of storage units in Step (c).

12. The method as claimed in claim 1, wherein the video data is a video layer or a video data.
